(19) United States
(12) Patent Application Publication
(10) Pub. No.: US 2011/0236782 A1
(43) Pub. Date: Sep. 29, 2011

(54) FUEL CELL SYSTEM

(75) Inventors: Hideo Nagaosa, Susono-shi (JP); Shinichi Matsumoto, Fuji-shi (JP); Haruyuki Nakanishi, Susono-shi (JP); Hidekazu Arikawa, Susono-shi (JP)

(73) Assignee: TOYOTA JIDOSHA KABUSHIKI KAISHA, Toyota-shi, Aichi (JP)

(21) Appl. No.: 13/120,095

(22) PCT Filed: Sep. 22, 2008
(86) PCT No.: PCT/JP2008/067121

§ 371 Date: Jun. 7, 2011

(51) Int. Cl. H01M 8/04

(52) U.S. Cl. 429/444; 429/447

(57) ABSTRACT

The power generation performance of a fuel cell is improved by reducing a concentration overvoltage of an anode, without increasing the cost thereof. A fuel cell system is provided with a fuel cell that generates electricity by means of electrochemical reactions between a fuel containing liquefied ammonia and an oxidizing agent, a fuel supply unit that supplies the fuel to the fuel cell, an oxidizing agent supply unit that supplies the oxidizing agent to the fuel cell, a temperature measurement unit that measures the temperature of the fuel cell, and a control unit that controls the pressure of the fuel to be supplied from the fuel supply unit to the fuel cell in accordance with the temperature of the fuel cell.

### TECHNICAL FIELD

The present invention relates to a fuel cell system.

### BACKGROUND ART

In recent years, fuel cells attract attention as power sources or supplies which are excellent in operating efficiency and environmental property. A fuel cell generates electric power by means of electrochemical reactions of fuel and an oxidizing agent. There is a fuel cell using an ion exchange membrane which allows positive ions or negative ions to permeate therethrough. For example, there has been known a fuel, cell using an anion exchange membrane (electrolyte membrane) which allows negative ions (anions) to permeate therethrough.

[First Patent Document] Japanese patent application laid-open No. 2006-244961

### DISCLOSURE OF THE INVENTION

### Problems to be Solved by the Invention

An oxidizing agent is supplied to a cathode side of a fuel cell which uses an anion exchange membrane, and a fuel containing compounds capable of reacting with negative ions to generate water is supplied to an anode side of the fuel cell. In this case, the fuel at the anode side reacts with the negative ions permeated from the cathode side to the anode side through the anion exchange membrane, thereby generating water.

Gaseous ammonia or aqueous ammonia may be used as the fuel supplied to the anode side. In the case of using gaseous ammonia, an interface (three-phase interface) of the gaseous ammonia, a catalyst layer, and the anion exchange membrane is needed. In order to make gaseous ammonia react at the three-phase interface in an efficient manner, a compound, being called ionomer, of the same kind as the anion exchange membrane is coated on the catalyst layer.

In cases where gaseous ammonia is used as fuel, the material cost of an ionomer to be coated increases, and at the same time, the process step of coating the ionomer on the catalyst layer increases, thus resulting in an increase in the total cost. In addition, in the case of using aqueous ammonia as fuel, a lot of water is mixed in the aqueous ammonia, so the concentration overvoltage at the anode increases. The present invention has been made in view of the problems as referred to above, and has for its object to provide a technique which serves to reduce the concentration overvoltage of an anode thereby to improve the power generation performance of a fuel cell, without increasing the cost.

### Means for Solving the Problems

In order to solve the aforementioned problems, a fuel cell system is provided with a control unit that serves to control the pressure of fuel to be supplied to a fuel cell from a fuel supply unit, which supplies the fuel to the fuel cell, in accordance with the temperature of the fuel cell.

Specifically, a fuel cell system is provided with a fuel cell that generates electricity by means of electrochemical reactions between a fuel containing liquefied ammonia and an oxidizing agent, a fuel supply unit that supplies the fuel to the fuel cell, an oxidizing agent supply unit that supplies an oxidizing agent to the fuel cell, a temperature measurement unit that measures the temperature of the fuel cell, and a first control unit that controls the pressure of the fuel to be supplied from the fuel supply unit to the fuel cell in accordance with the temperature of the fuel cell.

In the above-mentioned fuel cell system, the fuel containing liquefied ammonia is supplied to the fuel cell. The temperature of the fuel to be supplied to the fuel cell depends on the temperature of the fuel cell. That is, in cases where the temperature of the fuel cell is higher than the temperature of the fuel before being supplied to the fuel cell, when the fuel is supplied to the fuel cell, the temperature of the fuel rises to the temperature of the fuel cell or a nearby temperature. In cases where the temperature of the fuel cell is lower than the temperature of the fuel before being supplied to the fuel cell, when the fuel is supplied to the fuel cell, the temperature of the fuel falls to the temperature of the fuel cell or a nearby temperature.

Ammonia is a gas at standard (normal) temperature and pressure, but is liquefied by the application of pressure. The liquefaction pressure of ammonia depends on the temperature of ammonia. That is, when the temperature of ammonia rises, the liquefaction pressure of ammonia rises, and when the temperature of ammonia falls, the liquefaction pressure of ammonia falls. In cases where the pressure of the liquefied ammonia supplied to the fuel cell is lower than the liquefaction pressure of ammonia, the liquefied ammonia changes from a liquid state into a gas state. Therefore, the concentration overvoltage of an anode in the fuel cell rises, and hence the power generation efficiency of the fuel cell falls.

In the above-mentioned fuel cell system, the pressure of the fuel supplied to the fuel cell is controlled in such a manner that the liquefied ammonia contained in the fuel supplied to the fuel cell can maintain its liquid state. That is, the temperature of the fuel cell is measured, and the pressure of the fuel supplied to the fuel cell is controlled in accordance with the temperature of the fuel cell. For this reason, it becomes possible for the liquefied ammonia contained in the fuel supplied to the fuel cell to maintain its liquid state in the fuel cell. As a result, the concentration overvoltage of the anode in the fuel cell is reduced, and at the same time, it becomes possible to Improve the power generation performance of the fuel cell.

In addition, the above-mentioned fuel cell system may be further provided with a second control unit that controls the pressure of the oxidizing agent to be supplied from the oxidizing agent supply unit to the fuel cell. Then, the second control unit may control the pressure of the oxidizing agent to be supplied to the fuel cell in such a manner that the pressure of the oxidizing agent to be supplied to the fuel cell and the pressure of the fuel to be supplied to the fuel cell become equal to each other. According to the above-mentioned fuel cell system, by controlling the pressure of the oxidizing agent to be supplied from the oxidizing agent supply unit to the fuel cell, it is possible to make the pressure of the oxidizing agent to be supplied to the fuel cell and the pressure of the fuel to be supplied to the fuel cell equal to each other. As a result of this, it becomes possible to suppress the damage of an electrolyte membrane in the fuel cell due to the imbalance between the pressure of the fuel and the pressure of the oxidizing agent in the fuel cell.

Moreover, in the above-mentioned fuel cell system, the first control unit may control the pressure of the fuel to be supplied to the fuel cell in accordance with a change in temperature of the fuel cell. The temperature of the fuel supplied to the fuel cell depends on the temperature of the fuel cell. Thus, by controlling the pressure of the fuel to be supplied to the fuel cell in accordance with a change in temperature of the fuel cell, it becomes possible for the liquefied ammonia contained in the fuel supplied to the fuel cell to maintain its liquid state in the fuel cell.

Further, in the above-mentioned fuel cell system, the second control unit may control the pressure of the oxidizing agent to be supplied to the fuel cell in such a manner that in cases where there is a change in pressure of the fuel to be supplied to the fuel cell, the pressure of the oxidizing agent to be supplied to the fuel cell and the changed pressure of the fuel to be supplied to the fuel cell become equal to each other. According to the above-mentioned fuel cell system, by controlling the pressure of the oxidizing agent to be supplied from the oxidizing agent supply unit to the fuel cell, it is possible to make the pressure of the oxidizing agent to be supplied to the fuel cell and the changed pressure of the fuel to be supplied to the fuel cell equal to each other. As a result of this, it becomes possible to suppress the damage of the electrolyte membrane in the fuel cell due to the imbalance between the pressure of the fuel and the pressure of the oxidizing agent in the fuel cell.

In addition, a fuel cell system is provided with a fuel cell that generates electricity by means of electrochemical reactions between a fuel containing liquefied ammonia and an oxidizing agent, a fuel supply unit that supplies the fuel to the fuel cell, and an oxidizing agent supply unit that supplies the oxidizing agent to the fuel cell. By supplying the liquefied ammonia contained in the fuel to the fuel cell, the concentration overvoltage of an anode in the fuel cell is reduced, and at the same time, it becomes possible to improve the power generation performance of the fuel cell.

Moreover, the above-mentioned fuel cell system may be further provided with a first regulation unit that regulates the pressure of the fuel to be supplied from the fuel supply unit to the fuel cell, and a second regulation unit that regulates the pressure of the oxidizing agent to be supplied from the oxidizing agent supply unit to the fuel cell. In addition, in the above-mentioned fuel cell system, the second regulation unit may regulate the pressure of the oxidizing agent to be supplied to the fuel cell in such a manner that the pressure of the oxidizing agent to be supplied to the fuel cell and the pressure of the fuel to be supplied to the fuel cell become equal to each other. According to the above-mentioned fuel cell system, by regulating the pressure of the oxidizing agent to be supplied from the oxidizing agent supply unit to the fuel cell, it is possible to make the pressure of the oxidizing agent to be supplied to the fuel cell and the pressure of the fuel to be supplied to the fuel cell equal to each other. As a result of this, it becomes possible to suppress the damage of an electrolyte membrane in the fuel cell due to the imbalance between the pressure of the fuel and the pressure of the oxidizing agent in the fuel cell.

### EFFECT OF THE INVENTION

It becomes possible to reduce the concentration overvoltage of an anode thereby to improve the power generation performance of a fuel cell, without increasing the cost thereof.

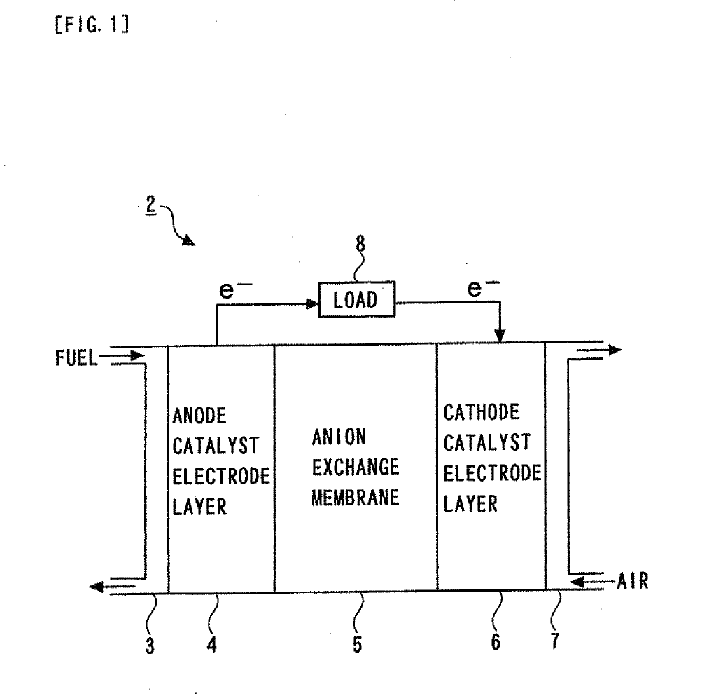

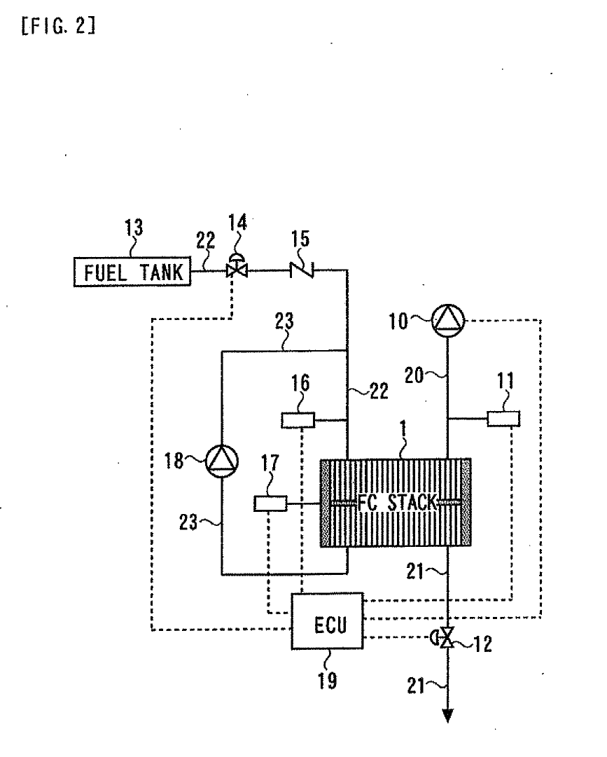

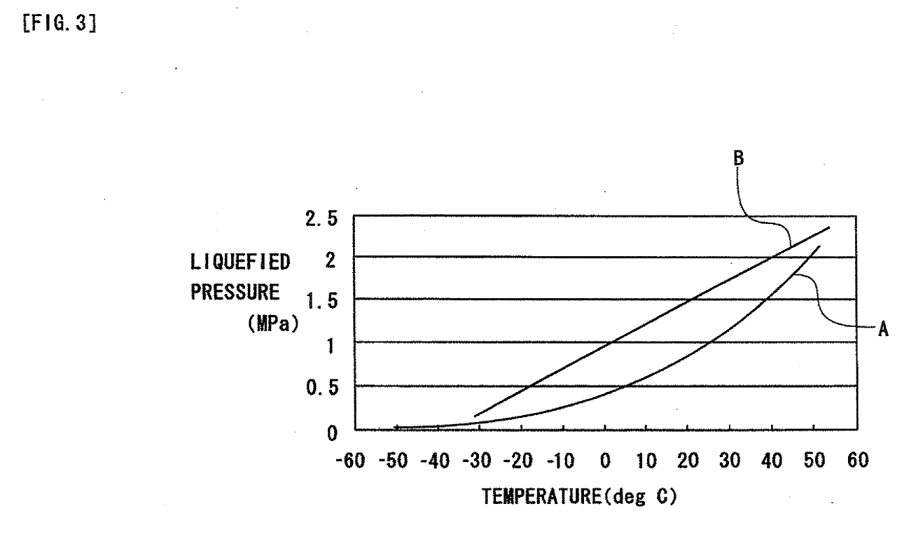

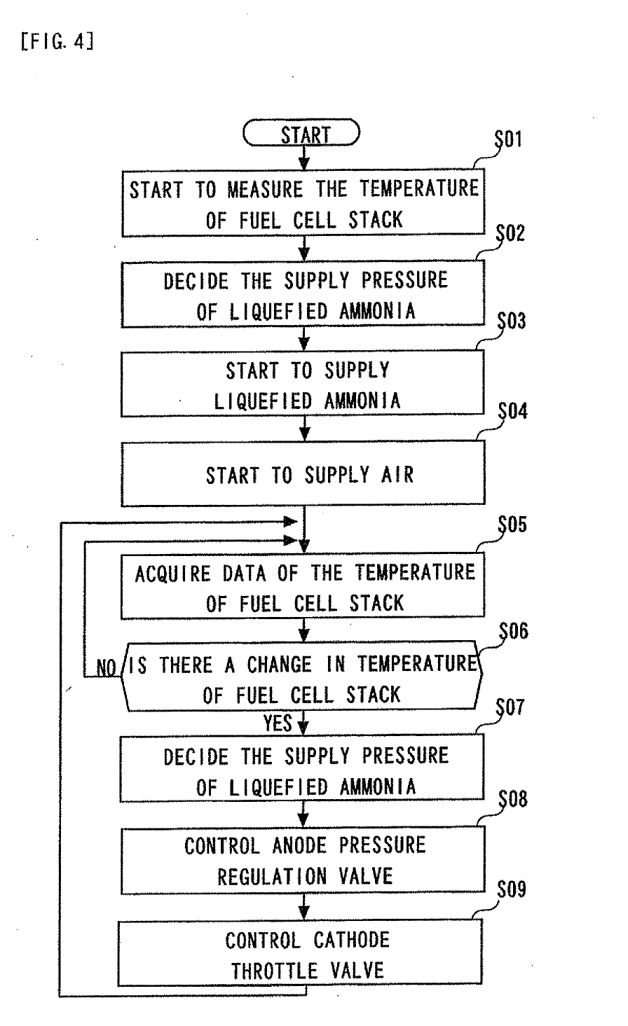

### BRIEF DESCRIPTION OF THE DRAWINGS

[FIG. 1] is a schematic diagram of a fuel cell stack.

[FIG. 2] is a view showing the construction of a fuel cell system.

[FIG. 3] is a graph showing the relation between the liquefaction pressure of ammonia and the temperature of ammonia.

[FIG. 4] is a flow chart showing the flow of processing of the fuel cell system.

### EXPLANATION OF REFERENCE NUMERALS AND CHARACTERS

1 . . . fuel cell (FC) stack
2 . . . fuel cell
3 . . . anode internal passage
4 . . . anode catalyst electrode layer
5 . . . anion exchange membrane
6 . . . cathode catalyst electrode layer
7 . . . cathode internal passage
8 . . . load
10 . . . air pump
11 . . . cathode pressure sensor
12 . . . cathode throttle valve
13 . . . fuel tank
14 . . . pressure regulating valve
15 . . . check valve
16 . . . anode pressure sensor
17 . . . temperature sensor
18 . . . fuel circulating pump
19 . . . electronic control unit (ECU)
20 . . . cathode passage
21 . . . cathode discharge passage
22 . . . anode passage
23 . . . anode circulation passage

### BEST MODE FOR CARRYING OUT THE INVENTION

Hereinafter, reference will be made to a fuel cell system according to the best mode (hereinafter referred to as an embodiment) for carrying out the present invention, while referring to the accompanying drawings. The construction of the following embodiment is only an example, but the present invention is not limited to such a construction of the embodiment.

FIG. 1 is a schematic diagram of a fuel cell (FC) stack with which the fuel cell system according to this embodiment is provided. The fuel cell stack 1 has a laminated or stacked structure in which a plurality of fuel cells 2 are laminated or stacked, and separators (not shown) are arranged at the opposite sides of each fuel cell 2, respectively. Each fuel cell 2 has an anode internal passage 3, an anode catalyst electrode layer 4, an anion exchange membrane 5, a cathode catalyst electrode layer 6, and a cathode internal passage 7. In addition, each fuel cell 2 may be of a structure having a membrane electrode assembly (MEA) in which the cathode catalyst electrode layer 6, the anion exchange membrane 5, and the anode catalyst electrode layer 4 are integrated or combined with one another. The anion exchange membrane 5 is an electrolyte membrane which allows negative ions or anions to permeate therethrough. The anode catalyst electrode layer 4 and the cathode catalyst electrode layer 6 are arranged at the opposite sides of the anion exchange membrane 5.

The anode internal passage 3 is connected to the anode catalyst electrode layer 4. The fuel which flows in from an inlet port of the anode internal passage 3 is supplied to the anode catalyst electrode layer 4, and unreacted fuel is discharged from the anode catalyst electrode layer 4. The cathode internal passage 7 is connected to the cathode catalyst electrode layer 6. The air which flows in from an inlet port of the cathode internal passage 7 is supplied to the cathode catalyst electrode layer 6, and unreacted air is discharged from the cathode catalyst electrode layer 6.

In the power generation processing of the fuel cell system according to this embodiment, the liquefied ammonia (NH₃) contained in the fuel is supplied to the anode catalyst electrode layer 4. Also, in the power generation processing of the fuel cell system according to this embodiment, air (oxidizing agent) containing oxygen (O₂) is supplied to the cathode catalyst electrode layer 6. When the liquefied ammonia is supplied to the anode catalyst electrode layer 4 and air is supplied to the cathode catalyst electrode layer 6, electrochemical reactions occur in the fuel cell stack 1 so that electrical energy is thereby generated.

When the liquefied ammonia is supplied to the anode catalyst electrode layer 4, the liquefied ammonia reacts with the hydroxide ions (OH⁻) which have passed through the anion exchange membrane 5, so that water (H₂O) and nitrogen (N₂) are thereby generated, and at the same time, electrons (e⁻) are emitted.

The electrochemical reaction in the anode catalyst electrode layer 4 is represented by the following equation (1).

2NH₃+6OH⁻→N₂+6H₂O+6e⁻ (1)

Here, note that most of the water generated by the electrochemical reaction of equation (1) above passes through the anion exchange membrane 5, but a part thereof remains in the fuel.

When air is supplied to the cathode catalyst electrode layer 6, the oxygen in the air, the water which has passed through the anion exchange membrane 5, and the electrons emitted from the anode catalyst electrode layer 4 react with one another, so that hydroxide ions are thereby generated. Here, note that water may be supplied to the cathode catalyst electrode layer 6 as necessary.

The electrochemical reaction in the cathode catalyst electrode layer 6 is represented by the following equation (2).

3H₂O+3/2O₂+6e⁻→6OH⁻ (2)

In the fuel cell stack 1, electric power is generated by the movement of the electrons emitted from the anode catalyst electrode layer 4 to the cathode catalyst electrode layer 6 by way of a load 8 such as an external circuit, etc.

The electrochemical reactions in the anode catalyst electrode layer 4 and the cathode catalyst electrode layer 6 are represented by the following equation (3).

2NH₃+3/2O₂→N₂+3H₂O (3)

The anion exchange membrane 5 need only be a medium which is able to cause the hydroxide ions generated by the cathode catalyst electrode layer 6 to move to the anode catalyst electrode layer 4. The anion exchange membrane 5 is, for example, a solid polymer membrane (anion exchange resin) which has an anion exchange group such as a primary to tertiary amino group, a quaternary ammonium group, a pyridyl group, an imidazole group, a quaternary pyridinium group, a quaternary imidazolium group, etc. In addition, the solid polymer membrane is, for example, a hydrocarbon based resin, a fluorine based resin, etc.

FIG. 2 is a view showing the construction of the fuel cell system according to this embodiment. As shown in FIG. 2, the fuel cell system according to this embodiment is provided with the fuel cell stack 1, an air pump 10, a cathode pressure sensor 11, a cathode throttle valve 12, a fuel tank 13, an anode pressure regulating valve 14, a check valve 15, an anode pressure sensor 16, a temperature sensor 17, a fuel circulating pump 18, and an electronic control unit (ECU) 19.

A cathode passage 20 for supplying air to the fuel cell stack 1 is connected to the fuel cell stack 1. The air pump 10 (corresponding to an oxidizing agent supply unit) for supplying air to the fuel cell stack 1 through the cathode passage 20 is connected to the cathode passage 20. The cathode pressure sensor 11 for measuring the pressure of the air supplied to the fuel cell stack 1 is connected to the cathode passage 20.

The air pump 10 and the cathode pressure sensor 11 are electrically connected to the electronic control unit 19. The air pump 10 is driven in response to a control signal from the electronic control unit 19. In addition, another control device, which is different from the electronic control unit 19, may control the drive of the air pump 10. By driving the air pump 10, the air sucked in from the ambient atmosphere is supplied to the fuel cell stack 1.

The cathode pressure sensor 11 measures the pressure of the air supplied to the fuel cell stack 1 in response to a control signal from the electronic control unit 19. The cathode pressure sensor 11 may measure the pressure of the air supplied to the fuel cell stack 1 in a continuous manner or at a predetermined interval. The data of the pressure of the air measured by the cathode pressure sensor 11 is sent to the electronic control unit 19 from the cathode pressure sensor 11. The electronic control unit 19 is composed of a CPU (Central Processing Unit), a RAM (Random Access Memory), a ROM (Read Only Memory), an input/output interface, and so on. The data of the pressure of the air sent to the electronic control unit 19 is recorded in the RAM which is incorporated in the electronic control unit 19.

A cathode discharge passage 21 for discharging the air discharged from the fuel cell stack 1 into the external atmosphere is connected to the fuel cell stack 1. The cathode throttle valve 12 for regulating the pressure of the air supplied to the fuel cell stack 1 is arranged on the cathode discharge passage 21. Because the back pressure of the air discharged from the fuel cell stack 1 is controlled by the cathode throttle valve 12, the pressure of the air supplied to the fuel cell stack 1 is adjusted. The cathode throttle valve 12 is electrically connected to the electronic control unit 19. The pressure of the air supplied to the fuel cell stack 1 Is controlled by the degree of opening of the cathode throttle valve 12. That is, the value of the pressure of the air supplied to the fuel cell stack 1 is adjusted to a predetermined value by controlling the degree of opening of the cathode throttle valve 12. The control of the degree of opening of the cathode throttle valve 12 is carried out by a control signal from the electronic control unit 19. The cathode throttle valve 12 and the electronic control unit 19 correspond to a second control unit. Here, note that a cathode pressure regulating valve may be arranged on the cathode passage 20 instead of arranging the cathode throttle valve 12 on the cathode discharge passage 21. Thus, the pressure of the air supplied to the fuel cell stack 1 may be regulated by means of the cathode pressure regulating valve.

An anode passage 22 for supplying fuel to the fuel cell stack 1 is connected to the fuel cell stack 1. The fuel tank 13 for supplying fuel to the fuel cell stack 1 Through the anode passage 22 is connected to the anode passage 22. The fuel supplied to the fuel cell stack 1 is stored in the fuel tank 13. A delivery valve for sending out or delivering the fuel stored in the fuel tank 13 to the anode passage 22 is mounted on the fuel tank 13. By opening the delivery valve, the fuel stored in the fuel tank 13 is sent out to the anode passage 22. The delivery valve is electrically connected to the electronic control unit 19, The opening and closing of the delivery valve is carried out by a control signal sent from the electronic control unit 19.

The anode pressure regulating valve 14 for regulating the pressure of the fuel supplied to the fuel cell stack 1 is arranged on the anode passage 22. The anode pressure regulating valve 14 is electrically connected to the electronic control unit 19. The pressure of the fuel supplied to the fuel cell stack 1 is controlled by the degree of opening of the anode pressure regulating valve 14. That is, the value of the pressure of the fuel supplied to the fuel cell stack 1 is regulated to a predetermined value by controlling the degree of opening of the anode pressure regulating valve 14. The control of the degree of opening of the anode pressure regulating valve 14 is carried out by a control signal from the electronic control unit 19. The anode pressure regulating valve 14 and the electronic control unit 19 correspond to a first control unit. Here, note that an anode throttle valve may be arranged on an anode circulation passage 23 instead of arranging the anode pressure regulating valve 14 on the anode passage 22. Thus, the pressure of the fuel supplied to the fuel cell stack 1 may be regulated by controlling the back pressure of the fuel discharged from the fuel cell stack 1.

The check valve 15 for checking or preventing the back or reverse flow of the fuel supplied to the fuel cell stack is arranged on the anode passage 22. The anode pressure sensor 16 for measuring the pressure of the fuel supplied to the fuel cell stack 1 is connected to the anode passage 22. The anode pressure sensor 16 is electrically connected to the electronic control unit 19. The anode pressure sensor 16 measures the pressure of the fuel supplied to the fuel cell stack 1 in response to a control signal from the electronic control unit 19. The anode pressure sensor 16 may measure the pressure of the fuel supplied to the fuel cell stack 1 in a continuous manner or at a predetermined interval. The data of the pressure of the fuel measured by the anode pressure sensor 16 is sent to the electronic control unit 19 from the anode pressure sensor 16. The data of the pressure of the fuel sent to the electronic control unit 19 is recorded in the RAM which is incorporated in the electronic control unit 19.

The temperature sensor 17 (corresponding to a temperature measurement unit) for measuring the temperature of the fuel cell stack 1 is connected to the fuel cell stack 1. The temperature sensor 17 is electrically connected to the electronic control unit 19. The temperature sensor 17 measures the temperature of the fuel cell stack 1 in response to a control signal from the electronic control unit 19. The temperature sensor 17 may measure the temperature of the fuel cell stack 1 in a continuous manner or at a predetermined interval. The data of the temperature of the fuel cell stack 1 measured by the temperature sensor 17 is sent to the electronic control unit 19 from the temperature sensor 17. The data of the temperature of the fuel cell stack 1 sent to the electronic control unit 19 is recorded in the RAM which is incorporated in the electronic control unit 19.

The anode circulation passage 23 for causing the fuel discharged from the fuel cell stack 1 to circulate through the anode passage 22 is connected to the fuel cell stack 1. The fuel circulating pump 18 is arranged on the anode circulation passage 23. By driving the fuel circulating pump 18, the fuel discharged from the fuel cell stack 1 flows into the anode passage 22 through the anode circulation passage 23.

A separator for separating water from the fuel discharged from the fuel cell stack 1 may be provided on the anode circulation passage 23. The water separated by the separator may be supplied to the cathode catalyst electrode layer 6. Also, the water separated by the separator may be discharged to the external atmosphere. In addition, a gas liquid separator for separating nitrogen from the fuel discharged from the fuel cell stack 1 may be provided on the anode circulation passage 23. The nitrogen separated by the gas liquid separator may be discharged to the external atmosphere.

The fuel containing liquefied ammonia is stored in the fuel tank 13. The liquefaction of the ammonia is decided by temperature and pressure. That is, the minimum pressure at which ammonia is able to maintain a liquid state changes in accordance with the temperature thereof. FIG. 3 is a graph which shows the relation between the liquefaction pressure (MPa) of ammonia and the temperature (deg C.) thereof at the time of pressurizing the ammonia. The axis of ordinate in FIG. 3 represents the liquefaction pressure (MPa) of ammonia, and the axis of abscissa in FIG. 3 represents the temperature (deg C.) of ammonia. A curve A shown in FIG. 3 indicates the liquefaction pressure of ammonia with respect to the temperature of ammonia.

As shown in FIG. 3, when the temperature of ammonia rises, the liquefaction pressure of the ammonia also rises. In this case, by making the pressure applied to the ammonia equal to or more than the liquefaction pressure of ammonia in accordance with the rise in the temperature of ammonia, the ammonia maintains its liquid state. For example, by applying pressure to the ammonia according to the rise in the temperature of the ammonia in a manner such that the relation between the pressure applied and the temperature of the ammonia becomes a straight line B, as shown in FIG. 3, the ammonia maintains its liquid state. The data related to the graph shown in FIG. 3 may be recorded in the ROM which is incorporated in the electronic control unit 19.

The liquefied ammonia is stored in the fuel tank 13 at a high pressure (for example, 0.85 MPa-2.5 MPa). The value of the pressure of the liquefied ammonia in the fuel tank 13 is illustrative, and may be other values. The pressure of the liquefied ammonia sent out to the anode passage 22 from the fuel tank 13 is reduced in pressure by means of the anode pressure regulating valve 14, and the liquefied ammonia, after being reduced in pressure, is supplied to the fuel cell stack. In the fuel cell system according to this embodiment, the liquefied ammonia is supplied to the fuel cell stack 1 at a pressure equal to or higher than the liquefaction pressure of ammonia. The electronic control unit 19 may adjust the pressure of the ammonia to be supplied by reference to the data on the pressure of fuel measured by the anode pressure sensor 16.

Next, the operation of the fuel cell system according to this embodiment will be explained. FIG. 4 is a flow chart showing the flow of processing of the fuel cell system according to this embodiment. The fuel cell system according to this embodiment executes the processing of FIG. 4, in cases where the processing of commencing a starting operation is carried out on the fuel cell system. For example, in cases where an ignition switch is turned on, the electronic control unit 19 may make a determination that there has been a command to commence a start operation of the fuel cell system, so that it carries out the processing of FIG. 4.

The temperature sensor 17 starts the measurement of the temperature of the fuel cell stack 1 (S01). The starting of the measurement of the temperature of the fuel cell stack 1 by means of the temperature sensor 17 is carried out by a start signal from the electronic control unit 19. The electronic control unit 19 acquires from the temperature sensor 17 the data of the temperature of the fuel cell stack 1 measured by the temperature sensor 17.

The electronic control unit 19 decides the supply pressure of the liquefied ammonia in accordance with the temperature of the fuel cell stack 1 acquired from the temperature sensor 17 (S02). The supply pressure of the liquefied ammonia means the pressure of the liquefied ammonia to be supplied to the fuel cell stack 1. The temperature of the liquefied ammonia supplied to the fuel cell stack 1 depends on the temperature of the fuel cell stack 1. That is, in cases where the temperature of the fuel cell stack 1 is higher than the temperature of the liquefied ammonia before being supplied to the fuel cell stack 1, the temperature of the liquefied ammonia, when supplied to the fuel cell stack 1, rises to the temperature of the fuel cell stack 1 or a temperature therearound. On the other hand, in cases where the temperature of the fuel cell stack 1 is lower than the temperature of the liquefied ammonia before being supplied to the fuel cell stack 1, the temperature of the liquefied ammonia, when supplied to the fuel cell stack 1, falls to the temperature of the fuel cell stack 1 or a temperature therearound. In this embodiment, the supply pressure of the liquefied ammonia is decided based on the temperature of the fuel cell stack 1.

The electronic control unit 19 may decide the supply pressure of the ammonia by reference to the data related to the graph shown in FIG. 3. Here, reference will be made to an example in which the electronic control unit 19 decides the supply pressure of the liquefied ammonia based on a straight line B shown in FIG. 3. For example, in cases where the temperature of the fuel cell stack 1 is 40 degrees C., the electronic control unit 19 decides the supply pressure of the liquefied ammonia as 2 MPa. As shown in FIG. 3, because 2 MPa is higher than the liquefaction pressure of ammonia, it becomes possible to supply the ammonia to the fuel cell stack 1 in its liquid state. In addition, reference will be made to another example in which the electronic control unit 19 decides the supply pressure of the liquefied ammonia. In cases where the temperature of the fuel cell stack 1 is T degrees C., the electronic control unit 19 calculates a liquefaction pressure P MPa for T degrees C. by reference to the data related to the graph in FIG. 3. Then, the electronic control unit 19 may decide a value, which is obtained by adding a predetermined value to P MPa, as the supply pressure of the liquefied ammonia.

Reverting to the explanation of FIG. 4, the electronic control unit 19 starts to supply the liquefied ammonia to the fuel cell stack 1 by controlling the delivery valve and the anode pressure regulating valve 14 of the fuel tank 13 (S03). In this case, the electronic control unit 19 opens the delivery valve of the fuel tank 13. Then, the electronic control unit 19 controls the anode pressure regulating valve 14 in such a manner that the supply pressure of the liquefied ammonia comes to be a supply pressure which is decided according to the temperature of the fuel cell stack 1. The electronic control unit 19 may adjust the supply pressure of the liquefied ammonia by reference to the data of the pressure of the fuel measured by the anode pressure sensor 16.

The electronic control unit 19 starts to supply air to the fuel cell stack 1 by controlling the air pump 10 and the cathode throttle valve 12 (S04). In this case, the electronic control unit 19 starts to drive the air pump 10. Then, the electronic control unit 19 controls the cathode throttle valve 12 in such a manner that the supply pressure of The air becomes a pressure equivalent to the supply pressure of the liquefied ammonia. To state in another way, the electronic control unit 19 controls the cathode throttle valve 12 in such a manner that the value of the supply pressure of the air becomes the same value or an approximate value as the supply pressure of the liquefied ammonia. Here, the supply pressure of the air means the pressure of the air to be supplied to the fuel cell stack 1. The electronic control unit 19 may adjust the supply pressure of the air by reference to the data of the pressure of the air measured by the cathode pressure sensor 11.

The electronic control unit 19 acquires from the temperature sensor 17 the data of the temperature of the fuel cell stack 1 measured by the temperature sensor 17 (S05). The electronic control unit 19 determines whether there is a change in the temperature of the fuel cell stack 1 (S06). In cases where there is no change in the temperature of the fuel cell stack 1 (i.e., NO in the processing of S06), the electronic control unit 19 carries out the processing of step S05. On the other hand, in cases where there is a change in the temperature of the fuel cell stack 1 (i.e., YES in the processing of S06), the electronic control unit 19 decides the supply pressure of the liquefied ammonia according to the changed temperature of the fuel cell stack 1 (S07).

The electronic control unit 19 controls the anode pressure regulating valve 14 in such a manner that the supply pressure of the liquefied ammonia comes to be a supply pressure which is decided according to the changed temperature of the fuel cell stack 1 (S08). The electronic control unit 19 may adjust the supply pressure of the liquefied ammonia by reference to the data of the pressure of the fuel measured by the anode pressure sensor 16.

The electronic control unit 19 controls the cathode throttle valve 12 in such a manner that the supply pressure of the air becomes a pressure equivalent to the supply pressure of the liquefied ammonia (S09). To state in another way, the electronic control unit 19 controls the cathode throttle valve 12 in such a manner that the value of the supply pressure of the air becomes the same value or an approximate value as the supply pressure of the liquefied ammonia. The electronic control unit 19 may adjust the supply pressure of the air by reference to the data of the pressure of the air measured by the cathode pressure sensor 11. After the processing of step S09, the electronic control unit 19 carries out the processing of step S05. In cases where there is a command to end the operation of the fuel cell system, the processing shown in FIG. 4 is ended.

In the fuel cell system according to this embodiment, liquefied ammonia is used as the fuel to be supplied to the fuel cell stack 1. In cases where liquefied ammonia is used as the fuel to be supplied to the fuel cell stack 1, it becomes unnecessary to coat an ionomer on the anode catalyst electrode layer 4. That is, a part of the liquefied ammonia supplied to the anode catalyst electrode layer 4 and a part of the water generated by the electrochemical reaction of the anode catalyst electrode layer 4 exist as ammonium ions (NH₄⁺) and hydrogen ions (H⁺) in the anode catalyst electrode layer 4. Therefore, the movement of the hydroxide ions passing through the anion exchange membrane 5 to the anode catalyst electrode layer 4 is facilitated. As a result of this, it becomes possible to carry out electrochemical reactions in the anode catalyst electrode layer 4 in an efficient manner even if an ionomer is coated on the anode catalyst electrode layer 4. Accordingly, it becomes possible to reduce the concentration overvoltage of the anode catalyst electrode layer 4 and at the same time to improve the power generation performance of the fuel cell system, without increasing the cost thereof.

In the case of the power generation process of the fuel cell system according to this embodiment, liquefied ammonia and air are supplied to the fuel cell stack 1. As mentioned above, in the electrochemical reactions in the anode catalyst electrode layer 4 and the cathode catalyst electrode layer 6, only nitrogen and water are generated, but carbon dioxide (CO₂) is not generated. On the other hand, in cases where a hydrocarbon based fuel is used, carbon dioxide is generated at the time of generation of electric power. With the use of liquefied ammonia as fuel, it becomes possible to suppress the generation of carbon dioxide during the time when the fuel cell system generates electric power. By suppressing the generation of carbon dioxide, it becomes possible to contribute to global warming prevention.

In the fuel cell system according to this embodiment, the pressure of the air supplied to the fuel cell stack 1 is controlled to a pressure equivalent to the pressure of the liquefied ammonia to be supplied to the fuel cell stack 1. As a result of this, pressure is applied to the fuel cells 2 in a uniform manner. Therefore, it becomes possible to suppress damage of the anion exchange membrane 5 due to the imbalance between the pressure of the liquefied ammonia and the pressure of the air in the fuel cell stack 1.

In the fuel cell system according to this embodiment, the pressure of the liquefied ammonia supplied to the fuel cell stack 1 is controlled in accordance with the temperature of the fuel cell stack 1. For example, the supply pressure of the liquefied ammonia is increased in accordance with the rise in temperature of the fuel cell stack 1. In addition, the supply pressure of the liquefied ammonia is decreased in accordance with the drop in temperature of the fuel cell stack 1. In cases where the supply pressure of the liquefied ammonia is increased, the supply pressure of the air is also increased. In cases where the supply pressure of the air is increased, the partial pressure of oxygen in the air increases, so it becomes possible to reduce the concentration overvoltage (diffusion polarization) of the cathode catalyst electrode layer 6. That is in the cathode catalyst electrode layer 6, the higher the partial pressure of oxygen in the air, the more becomes the opportunity for oxygen to react, so the concentration overvoltage of the cathode catalyst electrode layer 6 is accordingly reduced. As a result, it becomes possible to improve the power generation efficiency of the fuel cell system.

<Modification>

The fuel cell system according to the above-mentioned embodiment may be modified as follows. That is, the fuel cell system according to the above-mentioned embodiment may be modified in such a manner that the ammonia in an anode flow path of the fuel cell system may exist as a liquid at the design temperature of the fuel cell system. Here, the anode flow path of the fuel cell system is a distribution channel of ammonia which includes the fuel cell tank 13, the anode passage 22 and the anode internal passage 3. In addition, the design temperature of the fuel cell system is the highest temperature of the fuel cell stack 1 during the operation of the fuel cell system which is set by the design of the fuel cell system. The design temperature of the fuel cell system need only be calculated by means of experiments or simulations.

This modification changes the fuel cell system in such a manner that the pressure of the liquefied ammonia to be sent out from the fuel cell tank 13 to the anode passage 22 and the pressure of the liquefied ammonia to be supplied from the anode passage 22 to the fuel cell stack 1 becomes equal to or higher than a predetermined pressure. This predetermined pressure is a pressure at which the liquefied ammonia to be sent out from the fuel cell tank 13 to the anode passage 22 and the liquefied ammonia to be supplied from the anode passage 22 to the fuel cell stack 1 maintain their liquid states at the design temperature of the fuel cell system. That is, at the design temperature of the fuel cell system, the pressure of liquefied ammonia in the case where the liquefied ammonia to be sent out from the fuel cell tank 13 to the anode passage 22 and the liquefied ammonia to be supplied from the anode passage 22 to the fuel cell stack 1 exist in their liquid states becomes the predetermined pressure.

The fuel cell system according to this modification has a fixed pressure regulating valve in place of the pressure regulating valve 14. The fixed pressure regulating valve regulates the liquefied ammonia to be supplied to the fuel cell stack 13 to a predetermined pressure. The fixed pressure regulating valve which is incorporated in the fuel cell system according to this modification is beforehand set so that the liquefied ammonia to be supplied to the fuel cell stack 13 becomes the predetermined pressure. Accordingly, even if the fixed pressure regulating valve does not receive a control signal from the electronic control unit 19, it is possible for the fixed pressure regulating valve to regulate the liquefied ammonia to be supplied to the fuel cell stack 13 to the predetermined pressure.

In addition, in the fuel cell system according to this modification, the anode flow path is designed in such a manner that it can bear the pressure of the liquefied ammonia in the anode flow path in cases where the liquefied ammonia to be supplied to the fuel cell stack 13 is regulated to the predetermined pressure. That is, the anode passage 22 is designed in such a manner that the anode passage 22 may not be damaged even in cases where the pressure of the liquefied ammonia to be sent out from the fuel cell tank 13 becomes the predetermined pressure. In addition, the anode internal passage 3 is designed in such a manner that the anode internal passage 3 may not be damaged even in cases where the pressure of the liquefied ammonia to be supplied to the fuel cell tank 13 becomes the predetermined pressure.

Moreover, the fuel cell system according to this modification may have a cathode fixed valve in place of the cathode throttle valve 12. The cathode fixed valve regulates the pressure of the air to be supplied to the fuel cell stack 1 to a fixed value pressure by controlling the back pressure of the air discharged from the fuel cell stack 1. Here, the fixed value is a value at which the pressure of the air to be supplied to the fuel cell stack 1 becomes the same pressure as the pressure of the liquefied ammonia to be supplied to the fuel cell tank 13. The cathode fixed valve which is incorporated in the fuel cell system according to this modification is beforehand set so that the pressure of the air to be supplied to the fuel cell stack 1 becomes a fixed value. Accordingly, even if the cathode fixed valve does not receive a control signal from the electronic control unit 19, it is possible for the cathode fixed valve to regulate the pressure of the air to be supplied to the fuel cell stack 13 to the fixed value.

The fuel cell system according to this modification is provided with a cooling device that is arranged on the anode passage 22 for cooling the liquefied ammonia sent out from the fuel tank 13 to the anode passage 22. The cooling device arranged on the anode passage 22 is electrically connected to the electronic control unit 19. The electronic control unit 19 controls the cooling device by sending a control signal to the cooling device. The electronic control unit 19 supervises the temperature of the fuel cell stack 1 so that the temperature of the fuel cell stack 1 does not exceed the design temperature of the fuel cell system. In cases where the temperature of the fuel cell stack 1 exceeds the design temperature of the fuel cell system, the electronic control unit 19 may control the cooling device so as to lower the temperature of the liquefied ammonia to be supplied to the fuel cell stack 1.

In the fuel cell system according to this modification, even in cases where the temperature of the fuel cell stack 1 is equal to or lower than the design temperature of the fuel cell system, the liquefied ammonia to be supplied to the fuel cell stack 13 is regulated to the predetermined temperature. As a result of this even in cases where the temperature of the fuel cell stack 1 rises, liquefied ammonia can always be supplied to the fuel cell stack 1 under the condition of high pressure. That is, by regulating the liquefied ammonia to be supplied to the fuel cell stack 13 to the predetermined pressure, it becomes possible to supply the ammonia in its liquid state to the fuel cell stack 1.

1. A fuel cell system comprising:
a fuel cell that generates electricity by means of electrochemical reactions between liquefied ammonia and an oxidizing agent;
a fuel supply unit that supplies said liquefied ammonia to said fuel cell; an oxidizing agent supply unit that supplies said oxidizing agent to said
fuel cell;
a temperature measurement unit that measures the temperature of said fuel cell; and
a first control unit that controls the pressure of said liquefied ammonia, which is supplied from said fuel supply unit to said fuel cell, to a pressure at which said liquefied ammonia maintains its liquid state in accordance with the temperature of said fuel cell.

2. The fuel cell system as set forth in claim 1, further comprising:
a second control unit that controls the pressure of said oxidizing agent to be supplied from said oxidizing agent supply unit to said fuel cell;
wherein said second control unit controls the pressure of said oxidizing agent to be supplied to said fuel cell in such a manner that the pressure of said oxidizing agent to be supplied to said fuel cell and the pressure of said liquefied ammonia to be supplied to said fuel cell become equal to each other.

3. The fuel cell system as set forth in claim 1, wherein said first control unit controls the pressure of said liquefied ammonia supplied to said fuel cell in accordance with a change in temperature of said fuel cell.

4. The fuel cell system as set forth in claim 3, wherein said second control unit controls the pressure of said oxidizing agent to be supplied to said fuel cell in such a manner that in cases where there is a change in pressure of
said liquefied ammonia to be supplied to said fuel cell, the pressure of said oxidizing agent to be supplied to said fuel cell and the changed pressure of said liquefied ammonia to be supplied to said fuel cell become equal to each other.

5. A fuel cell system comprising:
a fuel cell that generates electricity by means of electrochemical reactions between liquefied ammonia and an oxidizing agent;
a fuel supply unit that supplies said liquefied ammonia to said fuel cell; an oxidizing agent supply unit that supplies said oxidizing agent to said
fuel cell;
a first regulation unit that controls the pressure of said liquefied ammonia, which is supplied from said fuel supply unit to said fuel cell, to a pressure at which said liquefied ammonia maintains its liquid state.

6. The fuel cell system as set forth in claim 5, further comprising:
a second regulation unit that regulates the pressure of said oxidizing agent to be supplied from said oxidizing agent supply unit to said fuel cell;
wherein said second regulation unit regulates the pressure of said oxidizing agent to be supplied to said fuel cell in such a manner that the pressure of said oxidizing agent to be supplied to said fuel cell and the pressure of said liquefied ammonia to be supplied to said fuel cell become equal to each other.
